(19) United States
(12) Patent Application Publication
(10) Pub. No.: US 2023/0105274 A1
(43) Pub. Date: Apr. 6, 2023

(54) DE-ESCALATING DEVICE

(71) Applicants: Matthew Speed, Mount, GA (US); Nicholas Cross, Rose Hill, KS (US)

(72) Inventors: Matthew Speed, Mount, GA (US); Nicholas Cross, Rose Hill, KS (US)

(21) Appl. No.: 17/835,355

(22) Filed: Jun. 8, 2022

Related U.S. Application Data
(60) Provisional application No. 63/208,585, filed on Jun. 9, 2021.

(51) Int. Cl. F41H 13/00; F42B 12/42; F41H 7/00; F41H 9/00; H04R 1/08; H04R 3/00; H04N 7/18

(52) U.S. Cl. CPC F41H 13/00; F42B 12/42; F41H 7/00; F41H 9/00; H04R 1/08; H04R 3/00; H04N 7/183; H04R 2499/13

(57) ABSTRACT

A de-escalation device has vehicle mount and an elongate arm connected to the vehicle mount. An expandable hook toward the end of the elongate arm is adjustable between a contracted position and an expanded position. The de-escalation device is configured to form a first opening in a wall structure by puncturing the end of the elongate arm through the wall structure while the hook is contracted and subsequently form a second, larger opening by withdrawing the elongate arm while the hook is expanded. The elongate arm can have proximal and distal arm sections that are rotatably adjustable with respect to the vehicle mount and one another. One or more remotely controllable de-escalation tools can be deployed from the end portion of the elongate arm.

### CROSS-REFERENCE TO RELATED APPLICATION

This application claims priority to U.S. Provisional Patent Application No. 63/208,585, of the same title, filed Jun. 9, 2021, which is hereby incorporated by reference in its entirety.

### FIELD

The present disclosure generally relates to a vehicle-mounted de-escalation device for law enforcement scenarios.

### BACKGROUND

Law enforcement is often called upon to diffuse tense situations in which suspects or hostages are positioned within a building or behind a wall or other blocking structure. A textbook example of this type of law enforcement scenario occurs when a potentially violent suspect who may harm himself or others is barricaded within or behind a structure. Law enforcement finds deescalating these situations to be challenging because access is restricted.

### BRIEF SUMMARY

In one embodiment, the present disclosure provides a de-escalation device. The de-escalation device includes a vehicle mount, an elongate arm, an expandable hook. The vehicle mount mounts the de-escalation device onto a vehicle. The elongate arm has a proximal end portion connected to the vehicle mount and a distal end portion opposite the end portion. The expandable hook is located on the distal end portion of the elongate arm and is adjustable between a contracted position and an expanded position. The de-escalation device is configured to form a first opening in a wall structure by movement of the distal end portion of the elongate arm in a first direction through the wall structure while the expandable hook is in the contracted position and subsequently form a second opening in the wall structure larger than the first opening by movement of the distal end portion of the elongate arm through the wall structure in a second direction opposite the first direction while the expandable hook is in the expanded position. The current embodiment also includes a method of de-escalating a law enforcement situation occurring within a building. The method includes driving a vehicle toward the building with an elongate arm extended in a direction of travel so that a distal end portion of the elongate arm penetrates a wall structure of the building, then expanding an expandable hook on the distal end portion of the elongate arm, then driving the vehicle away from the building with the expandable hook expanded such that the expanded hook forms an enlarged opening in the wall structure.

In another aspect, a de-escalation device comprises a vehicle mount for mounting the de-escalation device on a vehicle. An elongate arm comprises a proximal end portion connected to the vehicle mount and a distal end portion opposite the proximal end portion. An expandable hook is on the distal end portion of the elongate arm. The expandable hook is adjustable between a contracted position and an expanded position. The de-escalation device is configured to form a first opening in a wall structure by movement of the distal end portion of the elongate arm in a first direction through the wall structure while the expandable hook is in the contracted position and subsequently form a second opening in the wall structure larger than the first opening by movement of the distal end portion of the elongate arm through the wall structure in a second direction opposite the first direction while the expandable hook is in the expanded position.

In another aspect, a de-escalation device comprises a vehicle mount for mounting the de-escalation device on a vehicle. An elongate arm comprises a proximal arm section pivotably connected to the vehicle mount for rotation with respect to the vehicle mount about a first axis of rotation and a distal arm section pivotably connected to the proximal arm section for rotation with respect to the proximal arm section about a second axis of rotation. The elongate arm comprises a distal end portion configured to penetrate a wall structure. The elongate arm is adjustable by rotation of the proximal and distal arm sections about the first and second axes of rotation through a range of motion that includes a retracted position and at least one extended position. The distal end portion of the arm points generally in a vertical direction when the elongate arm is in the retracted position and points generally in a longitudinal direction when the elongate arm is in each extended position.

In another aspect, a de-escalation device comprises a vehicle mount for mounting the de-escalation device on a vehicle. An elongate arm is movably connected to the vehicle mount. The elongate arm comprises a proximal end portion connected to the vehicle mount and an opposite distal end portion. the distal end portion of the elongate arm is configured to penetrate a wall structure. One or more de-escalation tools is/are on the distal end portion of elongate arm. A remote control device is configured for remotely controlling the movable elongate arm and the one or more de-escalation tools.

In another aspect, a method of de-escalating a law enforcement situation occurring within a building comprises driving a vehicle toward the building with an elongate arm extended in a direction of travel so that a distal end portion of the elongate arm penetrates a wall structure of the building. An expandable hook on the distal end portion of the elongate arm is expanded. The vehicle is driven away from the building with the expandable hook expanded such that the expanded hook forms an enlarged opening in the wall structure.

In another aspect, a method of de-escalating a law enforcement situation occurring within a building comprises driving a vehicle toward the building with an elongate arm extended in a direction of travel so that a distal end portion of the elongate arm penetrates a wall structure of the building. A de-escalation tool on the distal end portion of the elongate arm is remotely deployed inside the building.

In another aspect, a method of de-escalating a law enforcement situation occurring within a building comprises adjusting an elongate arm on a vehicle from a retracted position to an extended position by actuating one or more actuators to rotate a proximal section of the elongate arm relative to the vehicle about a first pivot axis and rotate a distal section of the elongate arm relative to the vehicle about a second pivot axis. The vehicle is driven toward the building with elongate arm in the extended position so that a distal end portion of the elongate arm penetrates a wall structure of the building.

Other aspects, embodiments and features will be apparent hereinafter.

### BRIEF DESCRIPTION OF DRAWINGS

For a better understanding of the nature and objects of the disclosure, reference should be made to the following detailed description taken in conjunction with the accompanying drawings, in which:

FIG. 1 is an isometric view of an illustration of a de-escalation device.

FIG. 2 is an illustration of the de-escalation device mounted on a vehicle.

FIG. 3 is an elevation of the de-escalation device in a retracted position.

FIG. 4 is an elevation of the de-escalation device in an upwardly extended position.

FIG. 5. is an elevation of the de-escalation device in a forwardly extended position.

FIG. 6 is a perspective of the de-escalation device with an expandable hook thereof expanded.

FIG. 7. is an enlarged fragmentary elevation of a portion of the de-escalation device with an arm enclosure panel thereof removed to reveal the configuration of an internal linkage of the expandable hook when the expandable hook is contracted.

FIG. 8 is an enlarged fragmentary elevation similar to FIG. 7 but showing the expandable hook expanded.

FIG. 9 is a perspective of a prong of the expandable hook.

FIG. 10 is an enlarged elevation of a distal end of the de-escalation device.

Reference is made in the following detailed description of preferred embodiments to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

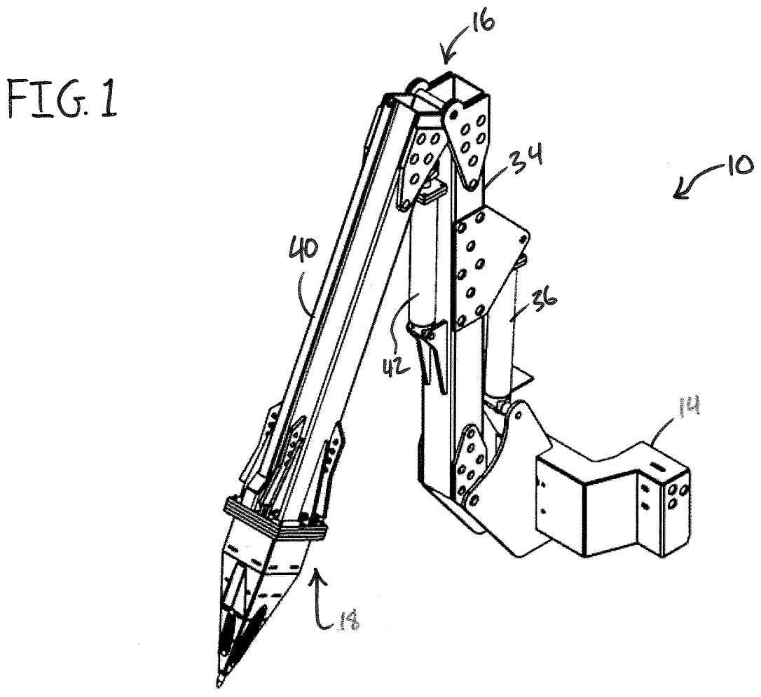

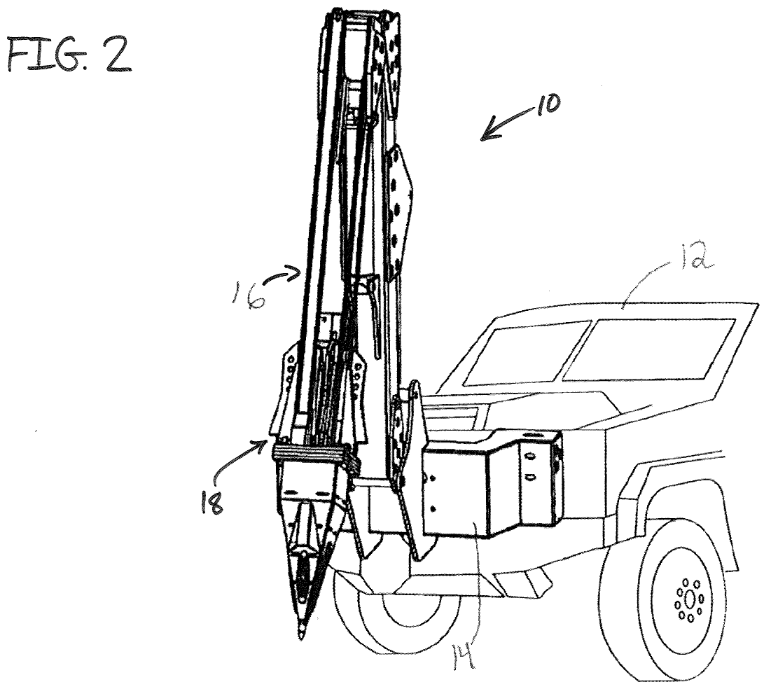

The present disclosure provides a de-escalation device generally indicated at 10 in FIG. 1. The de-escalation device 10 of the present disclosure can provide better access for law enforcement action in scenarios such as barricaded suspect situations in which an individual or group of individuals are separated from law enforcement by a blocking structure such as a wall of a building. Generally, the de-escalation device 10 of the present disclosure will be mounted on a vehicle 12, as seen in FIG. 2. The de-escalation device 10 broadly comprises a vehicle mount 14, an elongate arm 16, and an expandable hook 18 at the tip of the arm. As explained in further detail below, the de-escalation device 10 of the present disclosure is generally configured to penetrate a blocking structure such as a wall, a door, or window of a building. De-escalation tools of the device 10, including the expandable hook 18, can then be used inside on the other side of the blocking structure to de-escalate the situation.

The elongate arm 16 of the de-escalation device 10 includes a proximal end portion and an opposite distal end portion spaced apart from the proximal end portion along the length of the arm. The distal end portion of the arm tapers to a pointed tip (e.g., the illustrated tip has a pyramid shape). The expandable hook 18 is located at the distal end portion of the arm 16. The proximal end portion of the arm 16 attaches the vehicle mount 14 which mounts the device 10 on the vehicle 12. The vehicle 12 can be, for example, but not limited to, a wheeled or tracked armored SWAT vehicle such as a Lenco Bearcat vehicle.

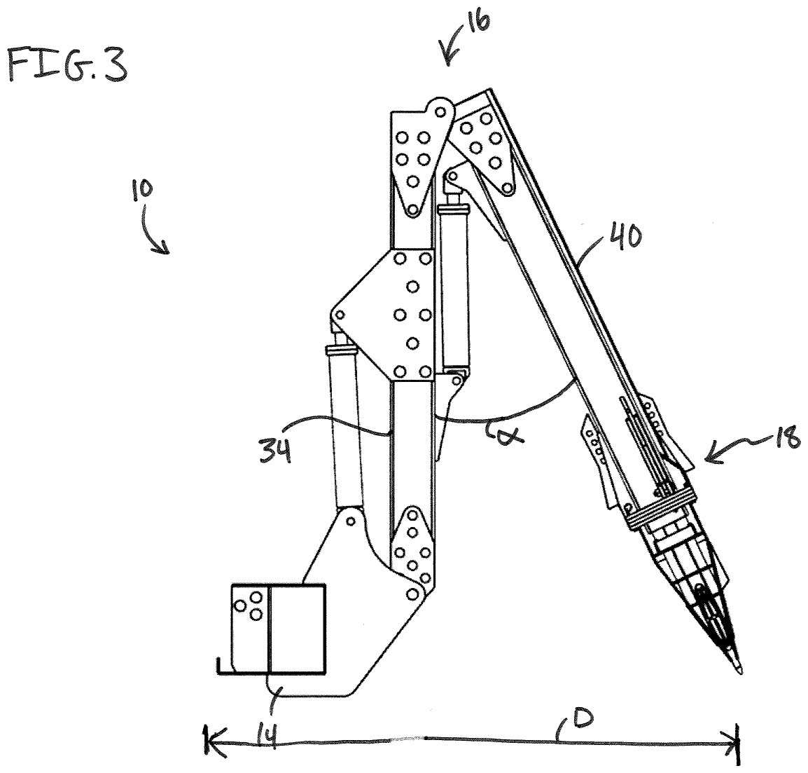

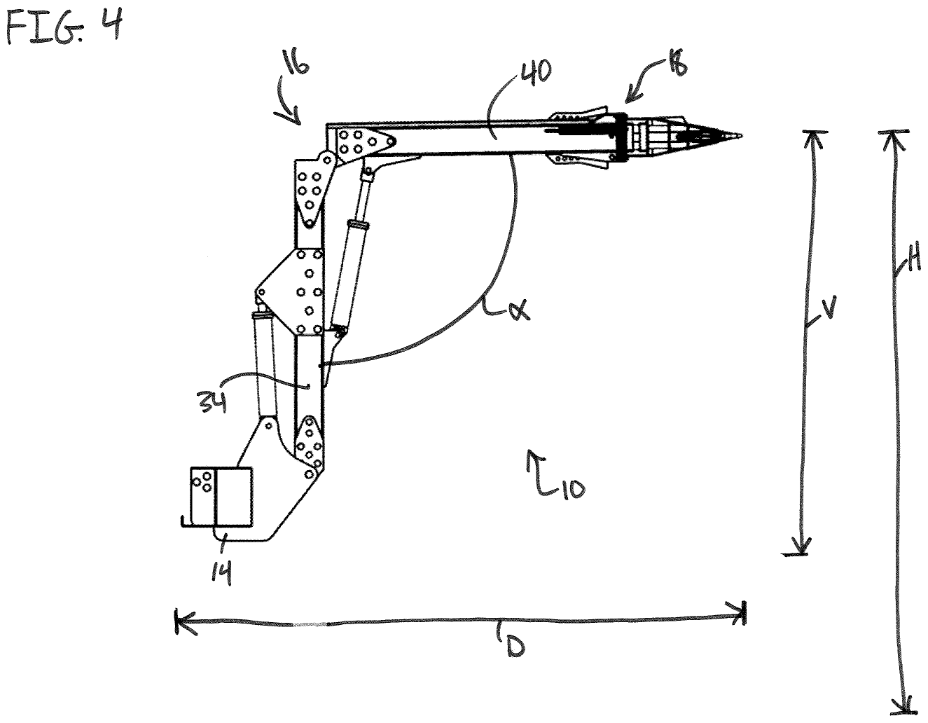

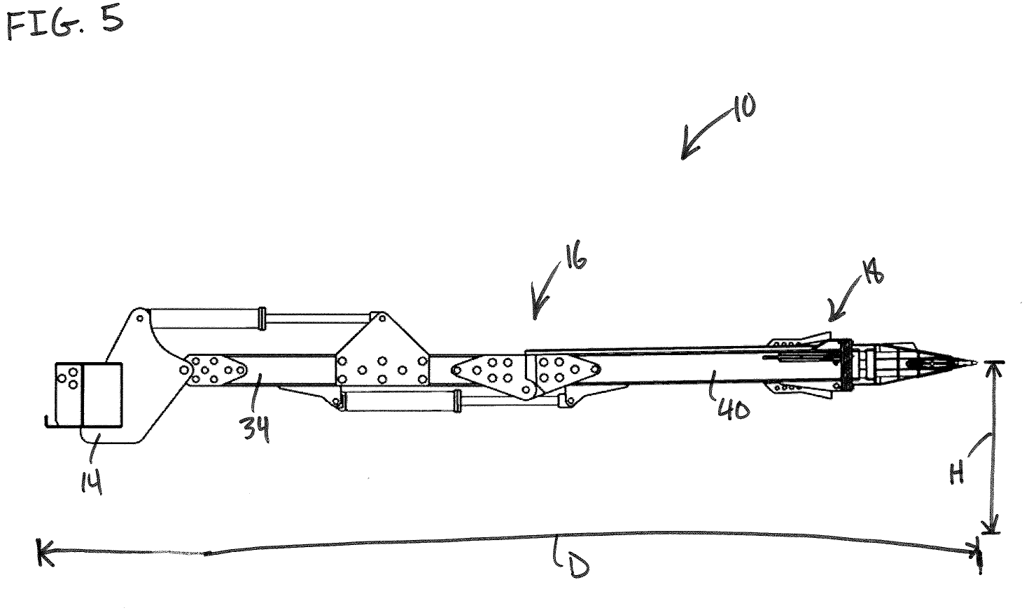

In the illustrated embodiment, the arm 16 articulates or moves in two sections, a proximal arm section 34 and a distal section 40. A first actuator 36 (e.g., a hydraulic cylinder) is connected between the vehicle mount 14 and the proximal arm section 34 for rotating the proximal arm section in relation to the vehicle mount about a first axis of rotation within a limited range of motion. Similarly, a second actuator 42 is connected between the proximal arm section 34 and the distal arm section 40 for rotating the distal arm section in relation to the proximal arm section about a second axis of rotation in a limited range of motion. In conjunction, the first actuator 36 and the second actuator 42 can drive the elongate arm 16 through a range of motion that includes (i) a retracted position, as shown in FIG. 3; (i) an upwardly extended position, as shown in FIG. 4; and (iii) a forwardly extended position, as shown in FIG. 5.

In the illustrated embodiment, in the retracted position, the proximal arm section 34 extends generally vertically upward from the vehicle mount 14 and the distal arm section 40 extends generally vertically downward from the proximal arm section. In one or more embodiments, the distal arm section 40 and the proximal arm section 34 define an included angle α between and below them of less than, for example, 45 degrees (e.g., less than 30 degrees). In the retracted position, the vehicle 12 can be driven on the road normally with minimal increase in vehicle clearances and minimal disruption to driver sight lines. In the retracted position, the distal end portion of the elongate arm 16 can be forwardly spaced from the front of the vehicle 12 by a back-to-front distance D of less than 84 inches (e.g., less than 72 inches). In the current embodiment, while in the retracted position, the distal end portion of the elongate arm 16 points generally vertically downward. Pointing generally vertically downward as opposed to generally forward reduces the likelihood of the arm 16 penetrating unintended structures while driving on the road.

From the retracted position, the de-escalation device 10 can move the arm 16 to the upwardly extended position by rotating the distal arm section 40 upward relative to the proximal arm section 34, e.g., by extending actuator 42. In the upwardly extended position, the proximal arm section 34 extends generally vertically upward and the distal arm section 40 extends generally forward from the proximal arm section. The included angle α between the proximal arm section 34 and the distal arm section 40 in the upwardly extended position can be greater than 45 degrees (e.g., greater than 60 degrees, about 90 degrees, etc.). The distal end portion of the arm points generally forward. In one or more embodiments, the distal end of the arm 16 is spaced apart above the mount 14 by a vertical spacing distance V in an inclusive range of from 72 inches to 120 inches in the upwardly extended position (e.g., 72 inches to 96 inches). Depending on the height at which the vehicle mount mounts onto the vehicle 12, the distal end of the arm 16 can be spaced apart above the ground by a height H in an inclusive range of from 96 inches to 180 inches in the upwardly extended position. In the upwardly extended position, the distal end portion of the arm 16 is forwardly spaced from the vehicle mount by a greater distance D than in the retracted position, e.g., a distance D of greater than 8 ft. In the upwardly extended position, the distal end portion of the de-escalation device 10 is positioned to penetrate upper floors (e.g., second story floors) of buildings. The vehicle can be driven forward with the deescalation device in the upwardly extended position so that the distal end portion of the arm penetrates the wall of the building at a second story location. It is also contemplated that the de-escalation device 10 could be mounted on the back of a vehicle in one or more embodiments, in which case the vehicle would be driven backward to penetrate the building with arm 16.

From the retracted position, the de-escalation device 10 can move the arm 16 to the forwardly extended position by rotating the distal arm section 40 upward relative to the proximal arm section 34 (e.g., by extending actuator 42) and rotating the proximal arm section forward relative to the vehicle mount 14 (e.g., by extending actuator 36). In the forwardly extend position shown in FIG. 5, the proximal and distal sections of the arm 16 are oriented in a substantially straight line (e.g., the included angle α between the two sections is about 180°). The distal end portion of the arm points generally forward. Depending on the height at which the vehicle mount 14 mounts onto the vehicle 12, the distal end of the arm 16 can be spaced apart above the ground by a height H of 18 inches to 60 inches in the forwardly extended position. In the forwardly extended position, the distal end portion of the arm 16 is forwardly spaced from the vehicle mount 14 by a greater distance D than in the retracted position, e.g., a distance D of greater than 10 ft (e.g., greater than 12 feet or greater than 14 feet). In the forwardly extended position, the distal end portion of the de-escalation device 10 is positioned to penetrate a first floor wall of a building. The vehicle 12 can be driven forward with the de-escalation device in the forwardly extended position so that the distal end portion of the arm penetrates the wall of the building at a first story location. In one or more embodiments, the distal end of the arm 16 is located at about the same height as the vehicle mount 14 in the forwardly extended position. It is also contemplated that the de-escalation device 10 could be mounted on the back of a vehicle in one or more embodiments, in which case the vehicle would be driven backward to penetrate the building with arm 16.

As mentioned above, the elongate arm 16 includes one or more de-escalation tools that can be operated on the other side of the blocking structure from the vehicle 12 to aid in de-escalating a situation unfolding in that location. Suitably, one or more de-escalation tools can be operated/actuated by one or more remote control devices (not shown) in operative communication with the de-escalation device.

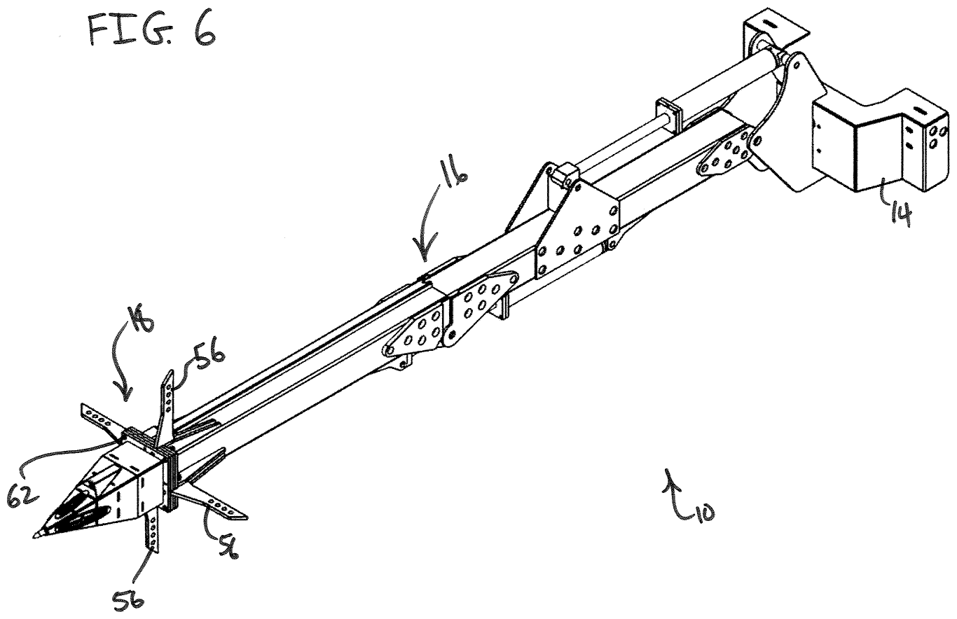

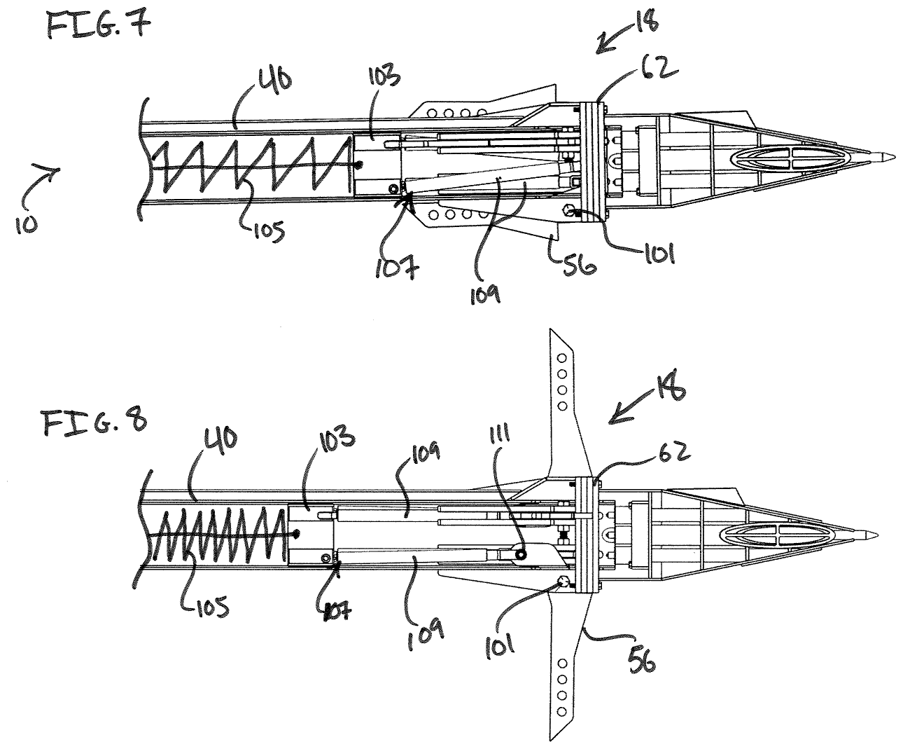

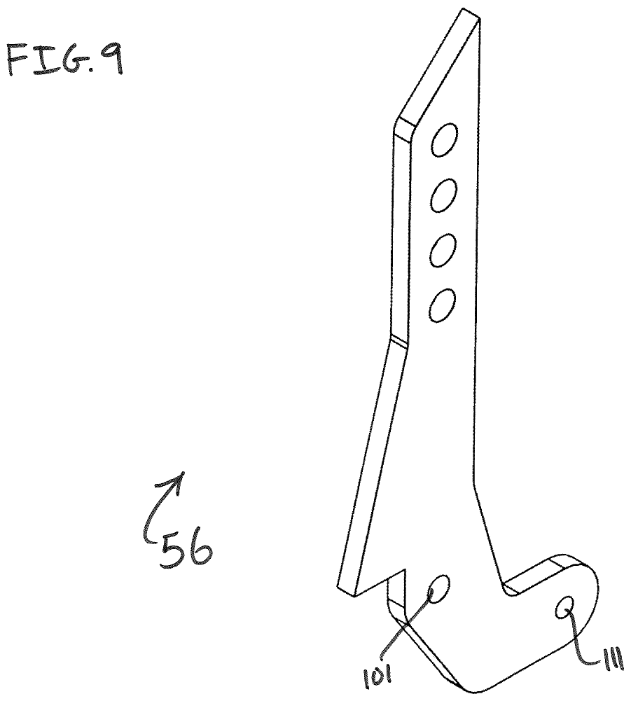

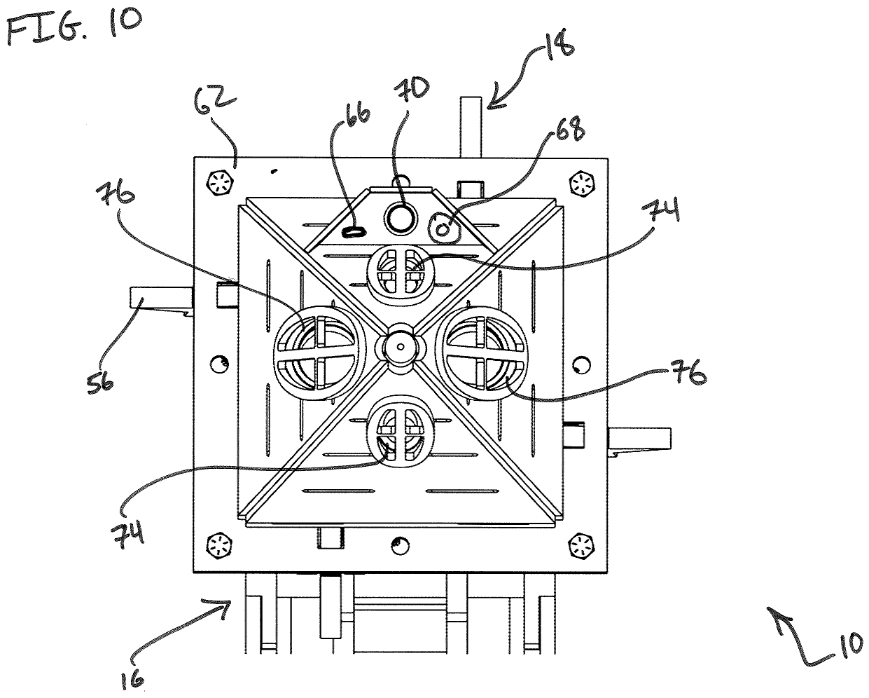

As mentioned above, one de-escalation tool of the illustrated device 10 is an expandable hook 18. As shown in FIGS. 6-9, the expandable hook 18 includes a plurality of adjustable prongs 56 at circumferentially spaced apart locations about the distal end portion of the elongate arm 16. Each prong 56 is connected to the arm 16 for pivoting with respect to the arm between a contracted position (FIG. 7) and an expanded position (FIG. 8). Each prong 56 has a free end, a pivoting end, and a length extending from the free end to the pivoting end. Each of the plurality of prongs 56 is connected to the elongate arm 16 at an arm-to-prong pivot point 101 (e.g., about a hinge pin) spaced apart along the length of the arm from the free end. Each of the plurality of prongs is pivotable about the arm-to-prong pivot point 101 with respect to the arm so that the free end rotates radially outwardly and distally to adjust the expandable hook from the contracted position to the expanded position. The distal end portion of the elongate arm 16 includes a stop flange 62. In the expanded position, the prongs 56 of the expandable hook 18 engage the stop flange 62 such that the stop flange braces the expandable hook against movement relative to the elongate arm 16 in a distal direction.

The de-escalation device 10 can include an actuator for adjusting the expandable hook 18 between the contracted position 24 and the expanded position 28. Referring to FIGS. 7 and 8, in the illustrated embodiment, the actuator includes a winch (not shown) operatively connected to a spring-loaded slider 103 in the distal section 40 of the arm 16. As shown, a spring 105 yieldably biases the slider 103 to a distal position inside the arm 16. The winch is connected to a cable for pulling the slider 103 proximally within the arm to a proximal position shown in FIG. 8, thereby resiliently deforming the spring. When the cable is let out, the spring 105 resiliently returns the slider 103 to the distal position.

A linkage 107 connects the slider 103 to the prongs 56 of the expandable hook 18. The linkage 107 is configured so that, when the slider 103 is in the distal position, the prongs 56 are in the contracted positions; and when the slider is pulled back to the proximal position, the prongs are in the expanded positions. Thus, when the slider 103 moves from the distal position to the proximal position, the free ends 60 of the plurality of prongs 56 rotate radially outward to expand the expandable hook 18. In the illustrated embodiment, the linkage 107 comprises a plurality of clevis-ended rods 109, each with a first end portion pivotably connected to the slider 103 and a second end portion pivotably connected to a respective prong 56 at a respective rod-to-prong pivot point 111 (e.g., about a clevis pin). As the slider 103 moves from the distal position to the proximal position, the rods 109 travel proximally with the slider. The devises at the proximal end portions of the rods 109 allow the rods to pivot with respect to the slider 103 to facilitate the proximal travel, and the devises at the distal end portions of the rods allow the prongs 56 to pivot about the rod-to-prong pivot points 11 with respect to the rods. The proximal movement of the rods 109 causes the prongs 56 to pivot radially outward and distally about the arm-to-prong pivot points 101 until the prongs 56 engage the stop flange 62.

In general, the expandable hook 18 enables the de-escalation device to optionally form an expanded opening in a wall structure after making an initial entry into a building via a relatively small first (penetration) opening. If the law enforcement situation requires additional access to the blocked premises, the winch (not shown) can retract the slider 103 to expand the expandable hook 18. Subsequently, the vehicle 12 can travel in a direction away from the building. With the expandable hook 18 in the expanded position, movement of the de-escalation device 10 in a direction away from the building causes the expanded prongs 56 to bear against the wall, creating tension on the wall structure. As the tension is applied, the stop flange 62 braces the expandable hook against movement relative to the elongate arm 16. Thus, the expanded hook 18 is pulled through the wall structure and forms a second opening in the wall structure larger than the first. In one or more embodiments, the second opening is large enough to allow law enforcement personnel to enter the previously blocked premises through the opening.

Thus, it can be seen that the expandable hook 18 can broadly be used to de-escalate a law enforcement situation by, for example, making initial access and penetration to a barricaded site and then opening wider access to the site. The expandable hook 18 may be considered a first de-escalation tool of the illustrated de-escalation device 10. A vehicle mounted de-escalation device 10 can also include other de-escalation tools in addition to or in lieu of the expandable hook.

Referring to FIG. 10, additional de-escalation tools supported at the distal end portion of the elongate arm 16 comprise a microphone 66 and a speaker 68. The microphone 66 can detect sound in the vicinity of the distal end portion of the arm 16, such as the voice of a suspect, and the speaker can convey sound to the vicinity of the distal end portion of the arm. A remote control device can be either electrically or wirelessly connected to the microphone 66 and include a speaker for outputting sound that is detected by the microphone. The remote control device is likewise connected to the speaker 68 and comprises a microphone that allows law enforcement to broadcast their voices via the arm-mounted speaker. The remote control device is located remote from the distal end portion of the elongate arm 16 so that law enforcement can use the microphone and speaker on the remote control device to communicate remotely with one or more persons on the opposite side of a blocking structure via the arm-mounted microphone 66 and the speaker 68 after the distal end portion of the arm has penetrated the blocking structure.

In certain embodiments, the distal end portion of the arm 16 can include a de-escalation tool comprising a digital video camera 70. In the current embodiment, the remote control device has a display. The display can remotely display images or videos, that can be captured from the camera 70. The display allows the operator, for instance, to visualize, an otherwise inaccessible location, for example, the inside of a building with the wall structure that the de-escalation device 10 has penetrated. As one skilled in the art would understand, the camera 70 and the remote display can provide law enforcement real-time video of what is happening on the other side of the blocking structure.

In one or more exemplary embodiments, the distal end portion of the elongate arm 16 can operatively support a de-escalation tool comprising a tear gas canister 76. The remote control device of the de-escalation device 10 can remotely actuate the tear gas canister 76 such that tear gas can be released from the distal end portion of the elongate arm 16. In some embodiments, the distal end portion of the elongate arm 16 can operatively support a de-escalation tool comprising a flashbang device 74 that can be remotely actuated by the remote control device. As one skilled in the art would understand, the tear gas canister 76 and the flash bang device 74 can provide non-lethal force to subdue and/or gain compliance of a suspect.

As one skilled in the art would further understand, all of the de-escalation tools described above can be used alone or in any combination, or in conjunction with other de-escalation tools not specifically mentioned here. Additionally, the de-escalation tools may vary in location in relation to the expandable hook 18 without departing from the scope of the present disclosure.

An exemplary method of using the de-escalation device in a barricaded suspect situation will now be briefly described. If conventional tactics for de-escalating a barricaded suspect situation have failed, a vehicle 12 including the de-escalation device 10 can be deployed to the site. The first de-escalation step is to penetrate the wall structure of the building to gain access to the other side. Depending on whether the suspect is located on a first or second story of the building, the arm 16 is extended to either the forwardly extended position or the upwardly extended position. Subsequently, the vehicle 12 is driven toward the building so that the arm 16 initially penetrates the building with the hook 18 in a contracted position, forming a first opening in the wall of relatively small cross-sectional size.

Once the end of the arm 16 penetrates the building, various de-escalation tactics can be deployed from the arm. For example, depending on the situation, law enforcement officers might monitor the situation using the camera 70 or attempt to communicate remotely with the suspect via the microphone 66 and the speaker 68. If advisable, law enforcement could remotely actuate a tear gas canister 74 or a flash bang device 74 in the suspect location. If these of de-escalation tactics also fail, officer entry into the site may be required.

If it is determined that officer access is required, the expandable hook 18 is expanded and the vehicle is driven away from the building, causing the hook 18 to form an enlarged second opening in the wall structure that is larger than the first opening. In an exemplary embodiment, law enforcement personnel then enter the building or other barricaded site through the enlarged second opening.

It can be seen that the de-escalation device 10 provides a useful tool for de-escalating certain law enforcement situations. Furthermore, the device 10 can be used with law enforcement officers positioned out of harm's way. Similarly, the device 10 uses various non-lethal, non-injurious tactics to protects suspects/bystanders from death or serious injury, while still providing tools for de-escalating and ultimately resolving the law enforcement situation.

The foregoing description has been presented for the purposes of illustration and description. It is not intended to be exhaustive or to limit the disclosure to the precise form disclosed. Many modifications and variations are possible in view of this disclosure. Indeed, while certain features of this disclosure have been shown, described and/or claimed, it is not intended to be limited to the details above, since it will be understood that various omissions, modifications, substitutions and changes in the apparatuses, forms, method, steps and system illustrated and, in its operation, can be made by those skilled in the art without departing in any way from the spirit of the present disclosure.

Furthermore, the foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments of the present disclosure are presented for purposes of illustration and description. They are not intended to be exhaustive or to limit the disclosure to the precise forms disclosed, many modifications and variations are possible in view of the above teachings. The embodiments were chosen and described in order to best explain the principles of the disclosure and its practical applications, to thereby enable others skilled in the art to best utilize the disclosed system and method, and various embodiments with various modifications as are suited to the particular use contemplated.

1. A de-escalation device comprising:
a vehicle mount for mounting the de-escalation device on a vehicle;
an elongate arm comprising a proximal end portion connected to the vehicle mount and a distal end portion opposite the proximal end portion; and
an expandable hook on the distal end portion of the elongate arm, the expandable hook being adjustable between a contracted position and an expanded position,
wherein the de-escalation device is configured to form a first opening in a wall structure by movement of the distal end portion of the elongate arm in a first direction through the wall structure while the expandable hook is in the contracted position and subsequently form a second opening in the wall structure larger than the first opening by movement of the distal end portion of the elongate arm through the wall structure in a second direction opposite the first direction while the expandable hook is in the expanded position.

2. The de-escalation device as set forth in claim 1, wherein the expandable hook comprises a plurality of adjustable prongs at circumferentially spaced apart locations about the distal end portion of the elongate arm.

3. The de-escalation device as set forth in claim 2, wherein each of the plurality of adjustable prongs is pivotably connected to the distal end portion of the elongate arm.

4. (canceled)

5. The de-escalation device as set forth in claim 1, wherein the distal end portion of the elongate arm comprises a stop flange distal of the expandable hook, the expandable hook being configured to engage the stop flange in the expanded position such that the stop flange braces the expandable hook against movement relative to the elongate arm in a distal direction.

6. The de-escalation device as set forth in claim 1, further comprising an actuator configured to adjust the expandable hook between the contracted position and the expanded position.

7. The de-escalation device as set forth in claim 6, wherein the actuator comprises a winch.

8. The de-escalation device as set forth in claim 7, further comprising a slider slidably received in the elongate arm, the winch being operatively connected to the slider for sliding the slider from a distal position to a proximal position.

9. The de-escalation device as set forth in claim 8, further comprising a linkage connected between the slider and the expandable hook, the linkage being configured to position the expandable hook at the contracted position when the slider is in the distal position and to position the expandable hook at the expanded position when the slider is in the proximal position.

10. The de-escalation device as set forth in claim 1, wherein the elongate arm comprises a proximal arm section pivotably connected to the vehicle mount and a distal arm section pivotably connected to the proximal arm section.

11. The de-escalation device as set forth in claim 10, further comprising a first actuator for pivoting the proximal arm section in relation to the vehicle mount and a second actuator for pivoting the distal arm section in relation to the proximal arm section.

12. The de-escalation device as set forth in claim 11, wherein the first actuator and the second actuator are configured to drive the elongate arm through a range of motion that includes a retracted position, an upwardly extended position, and a forwardly extended position.

13-15. (canceled)

16. The de-escalation device as set forth in claim 1, wherein the distal end portion of the elongate arm comprises one or more de-escalation tools.

17. The de-escalation device as set forth in claim 16, further comprising a remote control device for remotely controlling the de-escalation device including at least one of the one or more de-escalation tools.

18-22. (canceled)

23. A de-escalation device comprising:
a vehicle mount for mounting the de-escalation device on a vehicle;
an elongate arm comprising a proximal arm section pivotably connected to the vehicle mount for rotation with respect to the vehicle mount about a first axis of rotation and a distal arm section pivotably connected to the proximal arm section for rotation with respect to the proximal arm section about a second axis of rotation, the elongate arm comprising a distal end portion configured to penetrate a wall structure, the elongate arm being adjustable by rotation of the proximal and distal arm sections about the first and second axes of rotation through a range of motion that includes a retracted position and at least one extended position, wherein the distal end portion of the arm points generally in a vertical direction when the elongate arm is in the retracted position and points generally in a longitudinal direction when the elongate arm is in each extended position.

24-25. (canceled)

26. The de-escalation device as set forth in claim 23, wherein the distal end portion of the arm is spaced apart from the vehicle mount by a first longitudinal distance in the longitudinal direction when the elongate arm is in the retracted position and wherein the distal end portion of the arm is spaced apart from the vehicle mount by a second longitudinal distance in the longitudinal direction when the elongate arm is in the extended position, the second longitudinal distance being greater than the first longitudinal distance.

27. The de-escalation device as set forth in claim 26, wherein the first longitudinal distance is less than 5 feet and the second longitudinal distance is greater than 5 feet.

28-29. (canceled)

30. A de-escalation device comprising:
a vehicle mount for mounting the de-escalation device on a vehicle;
an elongate arm movably connected to the vehicle mount, the elongate arm comprising a proximal end portion connected to the vehicle mount and an opposite distal end portion, the distal end portion of the elongate arm being configured to penetrate a wall structure;
one or more de-escalation tools on the distal end portion of elongate arm; and
a remote control device for remotely controlling the movable elongate arm and the one or more de-escalation tools.

31. The de-escalation device as set forth in claim 30, wherein the one or more de-escalation tools includes a microphone configured to detect sound at the distal end portion of the elongate arm and the remote control device is configured to remotely output sound detected by the microphone.

32. The de-escalation device as set forth in claim 30, wherein the one or more de-escalation tools includes a speaker configured to output sound from the distal end portion of the elongate arm and the remote control device comprises at least one microphone enabling remote communication through the speaker.

33. The de-escalation device as set forth in claim 30, wherein the one or more de-escalation tools includes a camera and the remote control device comprises a display for remotely displaying images from the camera.

34. The de-escalation device as set forth in claim 30, wherein the one or more de-escalation tools includes a tear gas canister, the remote control device being configured to remotely actuate the tear gas canister.

35. The de-escalation device as set forth in claim 30, wherein the one or more de-escalation tools includes a flash bang device, the remote control device being configured to remotely actuate the flash bang device.

36-41. (canceled)
